(19) United States
(12) Patent Application Publication
(10) Pub. No.: US 2026/0109858 A1
(43) Pub. Date: Apr. 23, 2026

(54) FLAME-RETARDANT POLYAMIDE MOLDING COMPOUNDS

(71) Applicant: EMS-CHEMIE AG, Domat/Ems (CH)

(72) Inventor: Etienne AEPLI, Domat/Ems (CH)

(73) Assignee: EMS-CHEMIE AG, Domat/Ems (CH)

(21) Appl. No.: 19/362,898

(22) Filed: Oct. 20, 2025

(30) Foreign Application Priority Data
Oct. 22, 2024 (CH) 001153/2024

(51) Int. Cl. C08L 77/02; B29B 9/06; B29C 45/00; B29K 23/00; B29K 77/00; B29K 83/00; C08K 3/04; C08K 3/16; C08K 3/32; C08K 5/435; C08K 5/53

(52) U.S. Cl. CPC C08L 77/02; B29B 9/06; B29C 45/0001; C08K 3/04; C08K 3/16; C08K 3/32; C08K 5/435; C08K 5/53; B29C 2945/76498; B29C 2945/76531; B29K 2023/08; B29K 2077/00; B29K 2083/00; B29K 2995/0012; B29K 2995/0016; B29K 2995/0037; B29K 2995/0089; C08K 2201/005; C08K 2201/006; C08L 2201/02; C08L 2205/035

(57) ABSTRACT

Disclosed is a flame-retardant polyamide molding compound containing (A) 34-88 wt % of a semicrystalline, aliphatic polyamide with a C/N ratio of at least 8; (B) 6-21 wt % of flame retardant; (C) 1-10 wt % graphite; (D) 0-25 wt % polyamide elastomer; (E) 0-10 wt % plasticizer; (F) 0-10 wt % polyolefin; and (G) 0-5 wt % additives differing from (A) to (F); wherein the sum of (D) to (F) is 5 to 30 wt % relative to the sum of components (A) to (G), and wherein components (A) to (G) sum to 100 wt %.

### CROSS-REFERENCE TO A RELATED APPLICATION

This patent application claims the benefit of Swiss Patent Application No. 001153/2024, filed Oct. 22, 2024, which is incorporated by reference in its entirety for all purposes.

### TECHNICAL FIELD

The present invention relates to halogen-free, flame-retardant, polyamide molding compounds based on long-chain, aliphatic polyamides that have high LOI values and have good processing properties in extrusion processes. The invention further relates to production methods for such polyamide molding compounds and uses of the same.

### PRIOR ART

Flame-retardant polyamide molding compounds are known per se from the prior art.

A polyamide molding compound with a matrix made of polyamide 12, which additionally contains flame retardants and plasticizers, is known from EP-A-3 127 937. The molding compound may contain additional additives and polyolefin. In addition to polyamide 12, a polyamide elastomer based on polyamide 12 may be contained in the matrix. The molding compound is proposed for flexible components, particularly for flame-retardant applications in the rail sector. The processed examples contain no graphite, and it is also not disclosed that, by using graphite in such molding compounds at low concentrations of flame retardants, the LOI may be increased.

EP-A-3502186 describes a plasticized, flame-retardant, thermoplastic polyamide molding compound with particularly good processing properties, good flame retardance and good flexibility, as well as washout resistance, e.g., with respect to fuels, as well as uses of such polyamide molding compounds. The material is suitable, e.g., as a material for fuel lines in the automotive sector or for generally flexible moldings including lines, among others, for the rail sector. The polyamides are based on long-chain, aliphatic dicarboxylic acids. References to graphite are also lacking here.

Unreinforced, halogen-free, flame-retardant polyamide molding compounds and the uses thereof for producing electrical and/or electronic components are known from EP-A-2 410 020, wherein emphasis is placed in particular on the suitability for soldering processes. As the polyamide base, exclusively partially aromatic polyamides based on terephthalic acid are processed.

### SUMMARY OF THE INVENTION

It is thus the object of the present invention to provide a new, preferably unreinforced polyamide molding compound with sufficient flexibility, which is flame retardant while halogen-free, has a high LOI value (limiting oxygen index), and a sufficient notch impact strength at low temperatures, and has good processing properties in extrusion processes or extrusion blow molding processes, among others. The molding compound according to the invention is to have LOI values, determined by way of DIN EN ISO 4589-2:2017, of greater than 32%, preferably of at least 34%, particularly preferably of at least 36%.

This problem is solved by the molding compound defined in the claims, the production method for the molding compound defined in the claims, and the components made from such a molding compound as well as the uses of the molding compound as indicated in the claims.

The invention thus relates to a halogen-free, flame-retardant polyamide molding compound based on semicrystalline, aliphatic polyamides, which is suitable for railway applications, among others.

It was surprisingly determined that halogen-free flame retardants based on metal phosphinates, in combination with graphite, could be advantageously used for flexible polyamide molding compounds containing at least one of the components: platicizers, impact modifiers, polyamide elastomers. The proposed molding compounds are distinguished in particular by an LOI, determined according to DIN EN ISO 4589-2:2017, that is greater than 32%, preferably of at least 34%, particularly preferably of at least 36%, a tensile modulus of elasticity, determined according to ISO 527:2012, in the range of 500 to 1500 MPa, an elongation at break, determined according to ISO 527:2012, of more than 100%, and a notch impact strength at −45° C., determined according to ISO 179/1 (2023) or ISO 179/2 (2020), of preferably at least 4 kJ/m².

Specifically, the present invention relates to a polyamide molding compound comprising, preferably consisting of:
A 34-88 wt % semicrystalline, aliphatic polyamide with a C/N ratio of at least 8;
B 6-21 wt % flame retardants, consisting of:
B1 50-100 wt % of at least one metal phosphinate;
B2 0-50 wt % of at least one flame retardant synergist and/or at least one flame retardant containing nitrogen and phosphorus;
   where the sum of the components B1 and B2 yields 100 wt % of the component B;
C 1-10 wt % graphite;
D 0-25 wt % polyamide elastomer;
E 0-10 wt % plasticizer;
F 0-10 wt % polyolefin;
G 0-5 wt % additives, differing from A to F;
   where the sum of the weight proportions of components D to F is 5 to 30 wt % relative to the sum of the weight percentages of components A to G, and where the weight proportions of components A to G sum to 100 wt %.

The polyamide molding compound according to the invention is preferably free of reinforcing fibers, thus contains, in particular, no glass fibers or carbon fibers.

It is further preferred that there is no proportion of aromatic and/or partially aromatic polyamides within the polyamide molding compound.

In the meaning of the present invention, the term “polyamide” (abbreviation PA) is understood as a generic term which includes homopolyamides and copolyamides irrespective of their molar mass or their viscosity. The selected writing conventions and abbreviations for polyamides and their monomers correspond to those determined in ISO 16396-1 (2015(D)).

Concerning the polyamide (A) according to the invention, the monomers of the dicarboxylic acid components and the diamine components or the aminocarboxylic acids or lactams used, as well as the, if necessary, monofunctional controllers used by the condensation, form repeat units or end groups in the form of amides, which are derived from the respective monomers. As a rule, these make up at least 95 mol %, particularly at least 99 mol % of all repeat units and end groups present in the polyamide (A). In addition, the polyamide (A) may also have minor amounts of other repeat units, which may result from decomposition or secondary reactions of the monomers, for example, the diamines.

As for the quantities, it is to be emphasized that the subcomponents (B1) and (B2) are not related in quantity to the entire polyamide molding compound or to the sum of the weight percentages of the components (A) to (G), but instead the quantities indicated there relate in each case to 100% of the component (B), i.e., the sum of the quantities for the components (B1) and (B2) results in 100% of (B).

Insofar as quantities are subsequently indicated for the components (A)-(G), the indicated ranges are respectively understood to be in relation to the sum of the weight percentages of the components (A) to (G). It additionally applies that the sum of the weight proportions of the components (A) to (G) does not exceed 100 weight percent, that the sum of the weight proportions of the subcomponents (B1) and (B2) does not exceed 100 weight percent of the component (B).

The terms “containing” and “comprising” in the present claims and in the description mean that further components are not excluded. Within the context of the present invention, the term “consisting of” is to be understood as the preferred embodiment of the terms “containing” or “comprising”. When it is defined that a group “contains” a certain number of components, or “comprises” the same, this is to be understood such that a group is disclosed which preferably “consists” of these components. The term “consisting of” means that further components are excluded, and thus no further components are included in the molding compounds beyond the specifically named components.

The present invention is characterized in that, among others, at least one of the components (D), (E), and (F) has to be present in the molding compound in addition to the components (A), (B), and (C), wherein the sum of the components (D), (E), and (F) is 5 to 30 wt %, preferably 7 to 26 wt %, and particularly preferably 8 to 24 wt % or 10 to 24 wt %, in each case relative to the sum of the weight percentages of the components (A) to (G). This thereby means that at least one of the components (D), (E), and (F), thus (D) or (E) or (F), or a combination of two of these components or a combination of the three components (D), (E), and (F) is present in the molding compound.

Component (A): The polyamides of component (A) are semicrystalline, aliphatic polyamides, preferably long-chain, aliphatic polyamides, whose C/N ratio is at least 8, particularly preferably at least 10, more particularly preferably 10 to 13.

The C/N ratio of the respective polyamides results from the sum of the carbon atoms (C) of the monomers forming the polyamide units, thus the dicarboxylic acids, diamines, as well as lactams and aminocarboxylic acids, in relation to the sum of the nitrogen atoms (N) in these monomers, which may react to form amide bonds in the polyamide. If a polyamide contains several polyamide units (PA units for short), such as PA 11/913 (30:70 mol %), which comprises the PA units “11” and “913”, the C/N ratios of the individual PA units are weighted according to their mole fraction in polyamide. For the example PA 11/913 (30:70 mol %) this results in a C/N ratio of (0.3*11)+0.7*(9+13)/2=11.

In the meaning of the present invention, semicrystalline polyamides are those polyamides that have a melting point and have a melting heat of at least 20 J/g, particularly preferably from 20 to 80 J/g, in dynamic differential scanning calorimetry (DSC) at a heating rate of 20 K/m according to ISO 11357-3 (2013).

Within the context of the present invention, the term “aliphatic polyamide” means that the repeat units and the monomers, from which the polyamides derive, is exclusively based on acyclic (open-chain) and cyclic saturated or unsaturated carbon compounds, which have no aromatic structural units.

The polyamides (A) are preferably selected from the group consisting of PA610, PA612, PA614, PA616, PA1010, PA1012, PA1014, PA1016, PA11, PA12 or mixtures of the same. Among the polyamides A, those are preferred whose C/N ratio is at least 10. Thus, the polyamides PA1010, PA1012, PA11, PA12 or mixtures thereof are particularly preferred, polyamides PA 11 and PA12 are more particularly preferred.

Component (A) preferably has a solution viscosity, determined according to DIN EN ISO 307 (2007), in the range of ηᵣₑₗ=1.5-2.8, preferably in the range of ηᵣₑₗ=1.6-2.3, in each case measured at 20° C. in a solution of 0.5 g polymer dissolved in 100 ml of m-Cresol. The polyamide types PA1010, PA1012, PA11 and/or PA12 with a solution viscosity in the range of ηᵣₑₗ=1.5-2.8, preferably in the range of ηᵣₑₗ=1.6-2.3, are particularly preferred as component (A).

The polyamide types PA1010, PA1012, PA11 and/or PA12 with an average solution viscosity in the range of ηᵣₑₗ=1.8-2.1, or preferably in the range of ηᵣₑₗ=1.9 bis 2.0, are particularly preferred as component (A), as these types have advantages in terms of processability, particularly in extrusion processes. Advantageously, mixtures of these polyamide types with different solution viscosities are also used, wherein, however, all mixture components then have solution viscosities in the indicated ranges.

Advantageously, in particular with respect to a good processability, the molding compounds according to the invention have a melt volume-flow rate (MVR), determined according to ISO 1133 (2011) at 275° C. and at a 5 kg load, in the range of 3-120 cm³/10 min, particularly in the range of 5-100 cm³/10 min, more particularly preferably in the range of 10-60 cm³/10 min.

The polyamide molding compound is characterized according to one preferred embodiment in that the proportion of the component (A) is in the range of 48-84 wt %, preferably in the range of 53-78.9 wt. %, in each case relative to the sum of the weight percentages of the components (A) to (G).

Within the context of the present invention, polyamide molding compounds are thus preferred, which are characterized in that the polyamide A is selected as a polyamide with a C/N ratio of at least 10, preferably with a C/N ratio of 10 to 13, or is selected from the group consisting of PA610, PA612, PA614, PA616, PA1010, PA1012, PA1014, PA1016, PA11, PA12 or mixtures of the same, or is selected from the group consisting of PA1010, PA1012, PA11, PA12 and mixtures of the same, and/or has a solution viscosity in the range of ηᵣₑₗ=1.5-2.8, preferably in the range of ηᵣₑₗ=1.6-2.3, in each case measured at 20° C. in a solution of 0.5 g polymer dissolved in 100 ml m-Cresol, according to DIN EN ISO 307:2007.

Component (B): the flame retardant component (B) is present in the polyamide molding compound at a proportion of 6-21 wt % relative to the sum of the weight percentages of the components (A) to (G). This may thereby be a flame retardant consisting exclusively of metal phosphinate (B1) (or a mixture of this type of systems); however, it may also have added up to 50 wt % (B2) of at least one flame retardant synergist and/or at least one flame retardant containing nitrogen and phosphorus, which differs from component (B1). The percentage values are in each case related to the 100 weight percent of the component (B), i.e., the sum of (B1) and (B2) always yields 100 weight percent of the component (B).

The polyamide molding compound is characterized according to one preferred embodiment in that the proportion of the component (B) is in the range of 7-16 wt %, preferably in the range of 8-14 wt %, in each case relative to the sum of the weight percentages of the components (A) to (G).

Concerning the composition of component (B), it is further preferred that the component (B) is composed of 55-100 wt % (B1), 0-45 wt % (B2), preferably 60-100 wt % (B1), 0-40 wt % (B2), particularly preferably 75-98 wt % (B1), 2-25 wt % (B2), where the sum of the weight proportions of (B1) and (B2) in each case result in 100 weight percent of the component (B). In another preferred embodiment, component (B) consists exclusively of the component (B1), so that the component (B2) is not contained in the molding compound.

Preferably, the at least one metal phosphinate of the component (B1) is selected as phosphinic acid salt and/or diphosphinic acid salt, wherein it is preferably a phosphinic acid salt of the general formula (I) and/or formula (II) and/or polymers thereof

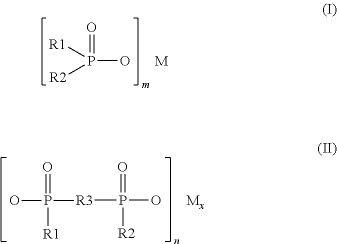

where
R1, R2 are equal or different and are preferably a C1-C8 alkyl, linear or branched, and/or are an aryl;
R3 are C1-C10 alkylene, linear or branched, C6-C10 arylene, alkylarylene, or arylalkylene;
M is a metal ion from the 2nd or 3rd main or subgroup of the periodic table; and
m is 2 or 3;
n is 1 or 3;
x is 1 or 2.

Preferably Al, Ca, and Zn are used as the metal ion M.

The component (B2) is preferably a melamine or condensation products of the melamine, e.g., melem, melam, melon, or reaction products of melamine with polyphosphoric acid or reaction products of condensation products of the melamine with polyphosphoric acid, or mixtures of the same.

Flame retardant synergists are suitable as component (B2), such as, e.g., stannates, particularly calcium stannate, zinc stannate, or zinc hydroxy stannate, as well as borates, such as, e.g., calcium borate or zinc borate, as well as metallocene compounds, particularly dicyclopentadienyl iron compounds, such as, e.g., ferrocene, as well as aluminum or zinc salts of phosphoric acid, as well as polyethyleneimines.

Melamine polyphosphate, zinc stannate, zinc borate, aluminum phosphite (aluminum salt of phosphoric acid), ferrocene, or polyethyleneimines are preferably used as component (B2).

The metallocenes are coordination compounds, namely complexes, so-called sandwich complexes. A representative is, for example, unsubstituted or substituted bis(is-cyclopentadienyl)iron. Bis(η⁵-cyclopentadienyl)iron is also called ferrocene.

Polyethyleneimines of the component (B2) are understood, in the meaning of the present invention, to be polymers, in whose main chains NH or N groups are present, which are respectively separated from each other by two methylene groups, and as they are described, for example, in Encycl. Polym. Sci. Eng. 1, 680-739. Homopolymerisates and also copolymerisates and derivatives thereof are also comprised within the meaning of the invention. Branched polyethyleneimine homopolymers are preferably used.

The homopolymerisates are generally obtained through polymerization of ethyleneimine (astidine) in aqueous or organic solution in the presence of acid releasing compounds, acids, or Lewis acids. These types of homopolymerisates are branched polymers, which generally contain primary, secondary, and tertiary amino groups in a ratio of approx. 30% to 40% to 30%. The distribution of the amino groups, determined by means of ¹³C-NMR spectroscopy, is, for the ratio of primary to secondary to tertiary amino groups, preferably in the range of 1:0.7:0.5 to 1:1.5:1, particularly 1:0.8:0.6 to 1:1.2:0.8.

Compounds are preferably used as comonomers, which have at least two amino functions. Suitable comonomers are called, for example, alkylene diamines with 2 to 10 carbon atoms in the alkylene radical, wherein ethylene diamine and propylene diamine are preferred. Additional suitable comonomers are diethylenetriamine, triethylenetetramine, tetraethylenepentamine, dipropylenetriamine, tripropylenetriamine, dihexamethylenetriamine, aminopropyl ethylenediamine, and bis-aminopropyl ethylenediamine. Preferred polyethyleneimines have a weight average molecular weight (weight average) Mw of 800 to 50′000 g/mol, particularly preferably 1′100 to 25′000 g/mol. The weight average molecular weight Mw is determined by means of light scattering according to ASTM D4001.

The polyethyleneimine of the component (B2) is preferably a branched polyethyleneimine homopolymer with a concentration of primary amino end groups in the range from 7,000-12,000 μeq/g (mmol/kg).

Melamine polyphosphate is particularly preferred as component (B2). These types of flame retardants are known from the prior art. Reference is made here to DE 103 46 3261, with regard to which the disclosed content of this document is explicitly included herein.

Concerning the flame retardants, it is particularly preferred if component (B2) and thus the entire polyamide molding compound has no melamine polyphosphate and/or melamine cyanurate.

Component (C): The polyamide molding compound is characterized according to one preferred embodiment in that the proportion of the component (C) is in the range of 2-8 wt %, preferably in the range of 3-7 wt. %, in each case relative to the sum of the weight percentages of the components (A) to (G). Component (C) is graphite.

Graphite is a naturally occurring modification of carbon. Its atoms are arranged in a hexagonal pattern in the shape of a hexagon, typical for carbon, and form a hexagonal layered grid in this way. Graphite retains the typical gray color due to its opaque gray to black crystals. Each carbon atom in each layer is linked to three others. A two-dimensional network of hexagons arises herefrom. Strong bonds prevail within each layer, yet the bonds between the different layers are quite weak. Thus, the layers can be easily displaced with respect to each other and even separated. For this reason, graphite is very soft and is therefore even used as a lubricant. Graphite is electrically and thermally conductive and has a good chemical resistance.

According to the invention, natural or synthetic graphite may be used. According to the invention, graphite may also be comminuted by grinding. The particle size is preferably in the range of 5 μm to 300 mm, particularly preferably in the range 5 μm to 25 mm. After grinding, the median particle size D50 (D50 median) of the graphite used according to invention is in the range of 3 to 30 μm, particularly preferably in the range of 5 to 20 μm. It is further preferred if the median particle size D90 (D90 median) is in the range of 10 to 25 μm. The specific surface area (BET) of the graphite used according to the invention, determined according to ASTM D-3037-93, is 5 to 50 m²/g, particularly preferably 10 to 30 m²/g. The graphite used according to the invention is preferably not an expandable graphite, i.e., the molding compound is preferably free of expandable graphite. This is because expandable graphite causes a rather low improvement in the LOI value and simultaneously negatively impacts the mechanical properties of the molding compound more strongly. Expandable graphite is produced by treating natural graphite with acids (sulfuric acid or nitric acid) and oxidizing agents (hydrogen peroxide, potassium permanganate, and chromic acid). By this means, the acids are incorporated between the graphite layers. During heating, expandable graphite expands to a multiple of the original volume.

As concerns the polyamide elastomer of Component (D), this is thereby preferably a polyamide elastomer composed of hard segments based on the polyamides PA610, PA612, PA614, PA616, PA1010, PA1012, PA1014, PA1016, PA11, PA12, preferably hard segments of the polyamides PA1010, PA1012, PA11, PA12, particularly preferably hard segments of PA12, and soft segments based on, preferably exclusively, polyether diol, dimer diol (based on dimeric fatty acids with 20-44 carbon atoms), and/or polyether diamine.

This polyether diol of the soft segment is preferably composed based on, preferably exclusively, at least one C2-C5, preferably C2-C4 polyoxyalkylene component, particularly preferably selected from the following group: ethylene oxide, propylene oxide, tetrahydrofuran, or a mixture of the same.

The dimer diols according to the invention with 20-44 carbon atoms, preferably with 24-36 carbon atoms, are preferably aliphatic or coaliphatic dioles, produced by dimerization of unsaturated fatty acids and subsequent hydrogenation. C36 dimer diol (CAS-No. 147853-32-5) and C44 dimer diol are particularly preferred.

Alternatively or additionally, the polyether diamine soft segment may preferably be composed based on, preferably exclusively, at least one C2-C5, preferably C2-C4 polyoxyalkylene component, particularly preferably selected from the following group: ethylene oxide, propylene oxide, tetrahydrofuran, or a mixture of the same.

According to one preferred embodiment, the polyamide hard segments have a number average molar mass in the range of 500 to 10000 g/mol, preferably 700 to 5000 g/mol, and particularly preferably 750 to 3000 g/mol.

On the other side, the soft segments have a number average molar mass preferably in the range from 200-4000 g/mol, particularly preferably in the range from 200-3000 g/mol, more particularly preferably 300-2500 g/mol.

According to one preferred embodiment, the proportion of polyamide hard segments is in the range of 45-95 wt %, preferably 50-80 wt %, and the proportion of soft segments is in the range of 5-55 wt %, preferably 20-50 wt %, in each case relative to the 100 wt % of the component (D).

One particularly preferred embodiment of component (D) is characterized in that it is free of ester bonds.

According to another embodiment, the polyamide elastomer has at least one amorphous phase, which preferably results from the soft segment unit, the ether proportion. The glass transition temperature or rather the glass transition point of this amorphous phase is, according to one preferred embodiment, at most 20° C. This amorphous phase of the polyether amides preferably has a glass transition point of less than 0° C., preferably less than −20° C. The glass transition point of the soft segment is preferably in the range of −70° C. to 0° C., particularly preferably in the range of −60° C. to −20° C., in each case determined by means of DSC measurement according to ISO 11357-2.

The production of the polyamide elastomers is preferably carried out in a one or two step polycondensation process. In the one step method, the polyamide forming components are mixed together with the dimer diol and/or the polyether components in, as much as possible, equimolar ratios of the end groups of the individual components, and polycondensed at temperatures in the range of 180 to 300° C. until the desired viscosity is achieved. If a targeted, block-by-block structure is sought, the two-step method is advantageously used. In this case, in a first step, the polyamide units marked with carboxy or amino end groups are formed at temperatures of 180 to 320° C. and at pressures of 0 to 20 bar, which are then subsequently polycondensed with the soft segment units at atmospheric pressure or reduced pressure (vacuum) at temperatures in the range of 180 to 280° C. into high molecular weight copolymers. If soft segment units with hydroxyl end groups are used, then esterification catalysts, e.g., organic titanates or zirconates, are advantageously used to accelerate the reaction.

The polyamide elastomers according to the invention preferably have a tensile modulus of elasticity of at most 1000 MPa, particularly preferably of at most 700 MPa and more particularly preferably of at most 600 MPa. The polyamide elastomers thus preferably have stiffnesses in the tensile modulus of elasticity range of 50 to 700 MPa, and particularly preferably in the range of 80 to 600 MPa.

The polyamide molding compound is characterized according to one preferred embodiment in that the proportion of the component (D) is in the range of 0-20 wt %, preferably in the range of 6-18 wt. % or 8-18 wt %, in each case relative to the sum of the weight percentages of the components (A) to (G).

Component (E): In the polyamide molding compound, there is a proportion of 0-10 wt % of plasticizers, relative to the sum of the weight percentages of the components (A) to (G). The plasticizer is thereby different from the other components of the polyamide molding compound, in particular, the plasticizer is not a system of the type according to (A), (B), (C), (D), (F), and/or (G). Component (E) is thus explicitly different from components (A), (B), (C), (D), (F), and/or (G). According to one preferred embodiment of the molding compound, the proportion of the plasticizer of the component (E) is present in the range of 0-7 wt %, preferably in the range of 1-6 wt. %, in each case relative to the sum of the weight percentages of the components (A) to (G). More particularly preferably, the proportion of the component (E) is in the range of 1-5 wt %, relative to the sum of the weight percentages of the components (A) to (G).

The plasticizer of component (E) is preferably based on an amide composed of aryl sulfonic acids with 2 to 12 carbon atoms, an ester composed of p-hydroxybenzoic acid with 2-20 carbon atoms in the alcohol component, a phosphonate or a phosphate. Silicone oils may also be preferably used as component (E).

The plasticizer of the component (E) is preferably selected from the group consisting of: aryl sulfonic acid amides with 2 to 12 carbon atoms, p-hydroxybenzoic acid ester with 2-20 carbon atoms in the alcohol component, organic phosphonates, organic phosphates, silicone oils.

Preferred phosphorus-containing plasticizers are, among others, diphenyl cresyl phosphate, tris (2-ethylhexyl) phosphate, diphenyl 2-ethylhexyl phosphate, tricresyl phosphate, alkyl or aryl phosphonates, diethyl phosphonate or cyclic phosphonates, e.g., Aflammit PLF 710.

Preferred esters of 4-hydroxybenzoic acid are p-hydroxybenzoic acid octyl ester, p-hydroxybenzoic acid ethyl ester, p-hydroxybenzoic acid i-hexadecylester, p-hydroxybenzoic acid 2-hexyldecylester.

Preferred representatives of aryl sulfonic acid amides are benzene sulfonic acid amide, benzene sulfonic acid-N-alkylamides, where the alkyl radicals carry a total of 1 to 20 carbon atoms, preferably benzene sulfonic acid-N-butylamide, benzene sulfonic acid-N-octylamide, benzene sulfonic acid-N-ethylhexylamide, benzene sulfonic acid-N-cyclohexylamide, toluene sulfonic acid amide, toluene sulfonic acid N-alkylamides where the alkyl groups contain 1 to 20 carbon atoms, preferably toluene sulfonic acid-N-ethylamide and toluene sulfonic acid-N-butylamide.

Furthermore, the plasticizer of the component (E) is preferably a silicone oil, which has siloxane-based chain molecules as the base structure. These are distinguished by the periodically alternating arrangement of silicon and oxygen atoms in the polymer main chain. In a more narrow sense, silicone oils are understood to be polymerized siloxanes with organic side chains (diorganopolysiloxane) with the general molecular formula [R¹R²SiO]n. A typical representative is, for example, polydimethylsiloxane, where the organic radicals R¹ and R² are methyl groups of the above formula. Silicone oils with an average molar mass of 162 to 150′000 g/mol, preferably from 500 to 20′000 g/mol are preferred. The kinematic viscosity, according to DIN 53019, is preferably in the range of 0.65 to 100′000 mm²/s (mPas), particularly preferably in the range of 10 to 1,000 mm²/s (mPas).

The component (E) preferably contains at least one of the following plasticizers, preferably, the component consists of at least one of the following plasticizers: polydimethylsiloxane, p-hydroxybenzoic acid octyl ester, p-hydroxybenzoic acid ethyl ester, p-hydroxybenzoic acid i-hexadecylester, p-hydroxybenzoic acid 2-hexyldecylester, benzene sulfonic acid amide, benzene sulfonic acid-N-alkylamides where the alkyl radicals carry a total of 1 to 20 carbon atoms, preferably benzene sulfonic acid-N-butylamide, benzene sulfonic acid-N-octylamide, benzene sulfonic acid-N-ethylhexylamide, benzene sulfonic acid-N-(2-hydroxypropyl)amide, benzene sulfonic acid-N-cyclohexylamide, o-toluene sulfonic acid amide, p-toluene sulfonic acid amide, o- or p-toluene sulfonic acid N-alkylamides where the alkyl groups contain 1 to 20 carbon atoms, preferably o-toluene sulfonic acid-N-ethylamide, p-toluene sulfonic acid-N-ethylamide, o-toluene sulfonic acid-N-butylamide, and p-toluene sulfonic acid-N-butylamide. The listed systems may be used individually or in mixtures. A mixture of benzene sulfonic acid-N-alkylamide and p-toluene sulfonic acid amide is particularly preferred.

The exclusive use of N-butylbenzenesulfonamide as component (E) is more particularly preferred.

The plasticizer preferably consists of an aryl sulfonamide, i.e., within the component (E), there are preferably only aryl sulfonamide systems as plasticizers, particularly preferably N-butylbenzenesulfonamide.

In another preferred embodiment, the plasticizer (E) consists exclusively silicone oils, particularly preferably silicone oils based on polydimethylsiloxane. Concerning an improvement of the LOI value, silicone oils appear to cause a synergistic effect as an interaction with graphite.

Component (F): In the polyamide molding compound, a proportion of up to 10 wt %, i.e., 0-10 wt % relative to the sum of the weight percentages of the components (A) to (G) may optionally be present. The proportion of the component F in the molding compound is preferably in the range of 0-7 wt %, preferably in the range of 1 to 6 wt %, in each case relative to the sum of the weight percentages of the components (A) to (G). More particularly preferably, the proportion of component (F) is in the range of 1-5 wt % relative to the sum of the weight percentages of the components (A) to (G).

According to one preferred embodiment, this polyolefin of the component (F) is composed based on at least one or a combination of the following components, preferably as a copolymer, particularly preferably as a terpolymer: ethylene, propylene, butylene, acrylate, methacrylate, acrylic acid, methacrylic acid, maleic anhydride, glycidyl methacrylate, diene, particularly butadiene, and/or isoprene. It is particularly preferably composed as an ethylene-propylene and an ethylene-butylene copolymer, which is grafted with maleic anhydride. And/or it is composed as an ethylene-methacrylic acid-acrylate terpolymer, which is neutralized with metal ions, particularly preferably with zinc ions.

According to another preferred embodiment, the at least one polyolefin of the component (F) is selected from the following group: ethylene propylene rubber (EPM, EPR), ethylene propylene diene rubber (EPDM), styrene-containing elastomers, particularly SEBS, SBS, SEPS, acrylate rubber, nitrile rubbers (NBR, H-NBR), silicone rubber.

According to another preferred embodiment concerning component (F), the at least one polyolefin is functionalized, preferably with maleic anhydride, acrylic acid, and/or glycidyl methacrylate. The degree of grafting is thereby preferably in the range of 0.05-10 wt %.

Furthermore, the component (F) is a polyolefin ionomer, preferably a polyolefin ionomer in which the present carboxyl groups are partially or completely neutralized by metal bases, such that the carboxylate groups have metal ions, preferably zinc ions. The polyolefin ionomer of the component (F) is particularly preferably a completely or partially neutralized copolymer, made of ethylene and (meth)acrylic acid and containing zinc ions.

Concerning the components (D), (E) and (F), it should be noted that at least one of these components has to be present in the molding compound, and that the sum of the components (D), (E) and (F) is 5 to 30 wt %, preferably 7 to 26 wt %, and particularly preferably 8 to 24 wt % or 10 to 24 wt %, in each case relative to the sum of the weight percentages of the components (A) to (G).

Component (G): As depicted above, the polyamide molding compound may contain, in the context of component (G), up to 5 wt % additives, relative to the sum of the weight percentages of the components (A) to (G). Here, as well, it should be emphasized that the additives of component (G) are different from the other components (A) to (F). The proportion of the component (G) in the molding compound is preferably in the range of 0-2.0 wt %, particularly preferably in the range of 0.1-2.0 wt %, in each case relative to the sum of the weight percentages of the components (A) to (G). According to one preferred embodiment, the additives of the component (G) are selected from the group consisting of stabilizers, anti-aging agents, antioxidants, antiozonants, processing stabilizers, processing aids, viscosity modifiers, light stabilizers, UV stabilizers, UV absorbers, inorganic heat stabilizers in particular based on copper halides and alkali halides, organic heat stabilizers, optical brighteners, crystallization accelerators, crystal growth inhibitors, flow aids, lubricants, glidants, mold release agents, colorants in particular dyes, inorganic pigments, organic pigments, carbon black, and mixtures of the same.

One particularly preferred embodiment of the proposed polyamide molding compound is characterized in that it is composed as follows: polyamide molding compound consisting of:
A 34-88 wt % polyamide selected from the group consisting of PA610, PA612, PA614, PA616, PA1010, PA1012, PA1014, PA1016, PA11, PA12 or mixtures of the same;
B 6-21 wt % flame retardants, consisting of:
B1 50-100 wt % of at least one metal phosphinate;
B2 0-50 wt % of at least one flame retardant synergist and/or at least one flame retardant containing nitrogen and phosphorus;
where the sum of the components B1 and B2 yields 100 wt % of the component B;
C 1-10 wt % graphite;
D 0-25 wt % polyamide elastomer made of PA610, PA612, PA614, PA616, PA1010, PA1012, PA1014, PA1016, PA11 or PA12 polyamide hard segments and soft segments based on, preferably exclusively, polyether diol made from at least one component selected from the following group: ethylene oxide, propylene oxide, tetrahydrofuran; where the polyamide elastomer is preferably free of ester bonds;
E 0-10 wt % plasticizer selected from the group consisting of: aryl sulfonic acid amides with 2 to 12 carbon atoms, p-hydroxybenzoic acid ester with 2-20 carbon atoms in the alcohol component, organic phosphonates, organic phosphates, silicone oils;
F 0-10 wt % polyolefin selected as a copolymer, composed from at least one or a combination of the following components: ethylene, propylene, butylene, acrylate, methacrylate, acrylic acid, methacrylic acid, preferably functionalized with maleic anhydride, and/or as a polyolefin ionomer;
G 0-5 wt % additives, differing from A to F;
   where the sum of the weight proportions of components D to F is 5 to 30 wt % relative to the sum of the weight percentages of components A to G, and where the weight proportions of components A to G sum to 100 wt %.

Another particularly preferred embodiment of the proposed polyamide molding compound is characterized in that it is composed as follows: Polyamide molding compound consisting of:
A 48-84 wt % polyamide selected from the group consisting of PA1010, PA1012, PA11, PA12 or mixtures of the same;
B 7-16 wt % flame retardants, consisting of
B1 50-100 wt % of at least one metal phosphinate selected from phosphinic acid salt and/or diphosphinic acid salt;
B2 0-50 wt % of at least one flame retardant synergist and/or at least one flame retardant containing nitrogen and phosphorus, selected from melamine polyphosphate, zinc stannate, zinc borate, ferrocene, or polyethyleneimine; where the sum of the components B1 and B2 yields 100 wt % of the component B;
C 2-8 wt % graphite;
D 0-20 wt % polyamide elastomer made of PA1010, PA1012, PA11 or PA12 polyamide hard segments and soft segments based on, preferably exclusively, polyether diol made from at least one component selected from the following group: ethylene oxide, propylene oxide, tetrahydrofuran; wherein the polyamide elastomer is preferably free of ester bonds;
E 0-7 wt % plasticizer selected as N-butylbenzenesulfonamide and/or silicone oil;
F 0-7 wt % polyolefin selected as a copolymer, composed from at least one or a combination of the following components: ethylene, propylene, butylene, acrylate, methacrylate, acrylic acid, methacrylic acid, preferably functionalized with maleic anhydride, and/or as a polyolefin ionomer;
G 0-2.0 wt % additives, differing from A to F;
   where the sum of the weight proportions of components D to F is 7 to 26 wt % relative to the sum of the weight percentages of the components A to G, and where the weight proportions of the components A to G sum to 100 wt %.

Polyamide molding compounds are preferred which are characterized in that they
have an elongation at break, determined according to ISO 527:2012, of at least 100%, particularly preferably of at least 120%;
and/or have a tensile modulus of elasticity, determined according to ISO 527:2012 in the range of 500 to 1500 MPa;
and/or have a notch impact strength at −45° C., determined according to ISO 179-1 (2023) or ISO 179-2 (2020), of at least 4 kJ/m²;
and/or have an LOI (limiting oxygen index), determined according to DIN EN ISO 4589-2:2017, of more than 32%, particularly preferably of at least 34%, and more particularly preferably of at least 36%.

Furthermore, the present invention relates to a method for producing a polyamide molding compound, as it was depicted above, which method is preferably characterized in that the components (A), (C), (D), (F), and (G) are pre-blended separately from the components made of (B) and are separately dosed into the feeder of a compounder. Alternatively, (B) may also be metered into the melt of (A), (D), and (F) via a side feeder. If necessary, component (E) is likewise separately pre-blended or pumped as a liquid into the molten mass of the remaining components. The components (F) and (G) may be selectively admixed with (A) or (B), wherein (A) is preferred. The melt is preferably degassed at atmospheric pressure or under vacuum in order to obtain a more compact granule.

Furthermore, the present invention relates to a granule, powder, or components made from a polyamide molding compound, as it was depicted above.

In particular, the present invention relates to flexible components, particularly for flame-retardant applications in the rail sector, preferably as a coating, covering, film, profile, tube, corrugated tube, hollow body, seal, panel, bracket, housing, sheath, electrical and electronic components, like preferably plugs and vents, preferably approved according to DIN EN 45545.

The components preferably have a tensile modulus of elasticity in the range of 500 to 1500 MPa and/or a elongation at break greater than 100% and/or a notch impact strength of greater than or equal to 4 kJ/m² at a temperature of −45° C.

The present invention additionally relates to a method for producing such an article. The method is preferably characterized in that a polyamide molding compound, as described above, is shaped into the article in an extrusion or extrusion blow molding process, an injection molding process or an overmolding process.

Last but not least, the present invention relates to the use of a polyamide molding compound, as it was depicted above, for producing such components.

Further embodiments of the invention are specified in the dependent claims.

### DETAILED DESCRIPTION OF THE PREFERRED EMBODIMENTS

Preferred embodiments of the invention are subsequently described by way of the exemplary embodiments, which merely function for explanation and are not to be interpreted as limiting.

### Production of the Polyamide Molding Compounds:

The component of the type (A) was compounded with the component (D), the component (B), the component (C), the component (F), and the additives of the component (G) in the proportions indicated in the following table according to the following method:

The raw materials of the components (A), (C), (D), (F), and (G) were pre-blended and gravimetrically metered via a belt scale into the feeder of a twin screw extruder, from Werner & Pfleiderer, model ZSK 25. Component (B) was gravimetrically metered separately into the feeder via a screw conveyor. Alternatively, component (B) may likewise be pre-blended with the components (A), (C), (D), (F), and (G), or is likewise gravimetrically metered separately into the feeder via a screw conveyor. The plasticizer (E) was metered in via a pump 5 zones upstream of the nozzle. Alternatively, the plasticizer may also be pre-blended with component (A) in an extruder. The throughput of the pump was previously calibrated: highly viscous plasticizers may be more easily processed using a heatable pump at an increased temperature. 2 zones upstream from the nozzle, the melt was degassed at atmospheric pressure (open degassing zone). It was processed at cylinder temperatures of 270-290°, at a screw speed of 200 rpm, and at a throughput of 15 kg/h. The compound was discharged via a nozzle and granulated after the strand was cooled. It was subsequently dried for 24 h in vacuum at 80° C.

### Production of the Moldings:

The production of the moldings was carried out on an injection molding machine, Arburg Allrounder 320-210-750, with an increasing cylinder temperature profile of 240-260° C. and injection pressures of 1200-1800 bar. The molding temperature was 40° C. The geometry of the moldings corresponds to the specifications of the corresponding test standards.

The compositions of the molding compounds and the properties of the moldings produced therefrom are summarized in table 1.

The following materials were used:
PA12: Polyamide PA12, solution viscosity ηᵣₑₗ=1.9 melting point of 178° C., EMS-CHEMIE AG
Graphite: Timrex KS15, synthetic graphite, particle size: 8 μm (D50), 17 μm (D90), specific surface area (BET): 20 m²/g, Imerys Graphite & Carbon Ltd.
PA-Elastomer: Grilflex ELG 3630, Polyetheramide with PA12 hard segments and soft segments based on tetrahydrofuran, solution viscosity ηᵣₑₗ=1.7, melting point Tm=155° C., EMS-CHEMIE AG
BBSA: N-butylbenzenesulfonamide
AK100 Silicone oil, polydimethylsiloxane with a viscosity of 100 mm²/s, Wacker
AK5000 Silicone oil, polydimethylsiloxane with a viscosity of 5000 mm²/s, Wacker
FR: Exolit OP1230, flame retardant, organic phosphorus salt, aluminum phosphinate, Clariant Int. AG
Polyolefin: Surlyn 9320, ethylene-methacrylic acid-acrylate terpolymer, partially neutralized using zinc ions, DuPont
Stabilizer: Mixture made of copper iodide and potassium iodide (wt ratio: 1:5)
Carbon black: Euthylen black 00-6005C4, PE Master batch with 40 wt % carbon black, BASF
Lupasol: Lupasol G20 WFR, Polyethyleneimine, BASF
Plutocen: Plutocen F—C, Ferrocene, Innospec

TABLE 1
Examples B1-B5 according to the invention

| | | B1 | B2 | B3 | B4 | B5 |
|---|---|---|---|---|---|---|
| PA12 (Component A) | wt % | 65.16 | 60.06 | 61.96 | 63.16 | 62.66 |
| FR (Component B1) | wt % | 11.0 | 11.0 | 11.0 | 11.0 | 11.0 |
| Graphite (Component C) | wt % | 5.0 | 5.0 | 5.0 | 3.5 | 5.0 |
| PA elastomer (Component D) | wt % | 10.0 | 17.6 | 15.7 | 16.0 | 18.5 |
| AK100 (Component E) | wt % | | | 2.0 | 2.0 | |
| AK5000 (Component E) | wt % | | 2.0 | | | 2.0 |
| BBSA (Component E) | wt % | 4.5 | | | | |
| Polyolefin (Component F) | wt % | 3.5 | 3.5 | 3.5 | 3.5 | |
| Stabilizer (Component G) | wt % | 0.24 | 0.24 | 0.24 | 0.24 | 0.24 |
| Carbon black (Component G) | wt % | 0.6 | 0.6 | 0.6 | 0.6 | 0.6 |

Properties

| | | | | | | |
|---|---|---|---|---|---|---|
| Modulus of elasticity | MPa | 820 | 1270 | 1370 | 1240 | 1420 |
| Breaking stress | MPa | 36.9 | 35.8 | 38.8 | 37.8 | 33.2 |
| Elongation at break | % | 206 | 171 | 170 | 170 | 120 |
| Notch impact 23° C. | kJ/m² | 7.4 | 10.1 | 9.7 | 11.8 | 11.3 |
| Notch impact - 45° C. | kJ/m² | 4.1 | 4.2 | 4.4 | 4.7 | 4.5 |
| LOI | % | 40 | 45 | 44 | 42 | 44 |
| MVR (275° C./5 kg) | cm³/10 min | 33.9 | 19.8 | 18.0 | 20.5 | 33.8 |

Notch impact = Notch impact strength

In comparison with the comparison examples VB1 and VB2, the examples B1 to B5 according to the invention show a significantly higher LOI, which is at least 40%. The addition of graphite causes a significant increase of the LOI value. Thus, the molding compound from example B1 has an LOI of 40%, while the molding compound from VB1 only has an LOI of 30%. Despite the use of graphite, the notch impact strength at low temperatures, the breaking stress and the elongation at break may be maintained at the level of the comparison examples.

If the plasticizer N-butylbenzenesulfonamide is replaced by polydimethylsiloxane (silicone oil), the LOI increases significantly yet again, as the comparison of the examples B1 and B2 shows. The increase of the LOI value is thereby higher if graphite is contained in the molding compound. A comparison of VB1 with VB2 shows that the LOI only increases by 2% if silicone oil is used instead of N-butylbenzenesulfonamide. In contrast, the LOI increases by 5% if the molding compound contains graphite, as in B) and B2.

TABLE 2
Examples B6-B8 according to the invention
and also Comparison examples VB1 and VB2

| | | VB2 | VB1 | B6 | B7 | B8 |
|---|---|---|---|---|---|---|
| PA12 (Component A) | wt % | 61.96 | 70.16 | 57.66 | 52.96 | 62.16 |
| FR (Component B1) | wt % | 11.0 | 11.0 | 11.0 | 11.0 | 11.0 |
| Plutocen (Component B2) | | | | | | 0.5 |
| Lupasol (Component B2) | wt % | | | 5.0 | 10.0 | |
| Graphite (Component C) | wt % | | | 5.0 | 5.0 | 5.0 |
| PA elastomer (Component D) | wt % | 20.7 | 10.0 | 18.5 | 18.2 | 18.5 |
| AK100 (Component E) | wt % | | | | | |
| AK5000 (Component E) | wt % | 2.0 | | 2.0 | 2.0 | 2.0 |
| BBSA (Component E) | wt % | | 4.5 | | | |
| Polyolefin (Component F) | wt % | 3.5 | 3.5 | | | |
| Stabilizer (Component G) | wt % | 0.24 | 0.24 | 0.24 | 0.24 | 0.24 |
| Carbon black (Component G) | wt % | 0.6 | 0.6 | 0.6 | 0.6 | 0.6 |

Properties

| | | | | | | |
|---|---|---|---|---|---|---|
| Modulus of elasticity | MPa | 1010 | 620 | 1430 | 1270 | 1380 |
| Breaking stress | MPa | 32.9 | 44.9 | 33.7 | 29.8 | 32.6 |
| Elongation at break | % | 161 | 250 | 140 | 170 | 125 |
| Notch impact 23° C. | kJ/m² | 16.0 | 11.9 | 9.5 | 9.2 | 9.4 |
| Notch impact - 45° C. | kJ/m² | 4.5 | 4.2 | 4.2 | 4.1 | 4.2 |
| LOI | % | 32 | 30 | 46 | 50 | 45 |
| MVR (275° C./5kg) | cm³/10 min | 14.9 | 27.9 | 55.3 | 97.3 | 38.8 |

Notch impact = Notch impact strength

If not otherwise noted, the measurements were carried out according to the following standards and on the following test specimens in the dry state. That is, after the injection molding, the test specimens were stored for at least 48 h at room temperature in a dry environment over silica gel, before they were supplied to the tests.

The thermal behavior (melting point) (TM), melting enthalpy (ΔHm), glass transition temperature (Tg)) was determined on the granules according to ISO-Norm 11357:2013 (11357-2 for the glass transition temperature, 11357-3 for the melting temperature and the melting enthalpy). Differential scanning calorimetry (DSC) was carried out with a heating rate of 20° C./min.

The relative viscosity (ηᵣₑₗ) was determined according to DIN EN ISO 307:2007 on solutions of 0.5 g polymer dissolved in 100 ml m-cresol at a temperature of 20° C. Granules were used as the sample.

Tensile modulus of elasticity, breaking strength, and elongation at break: Tensile modulus of elasticity, breaking strength, and elongation at break were determined according to ISO 527 (2012) at a traction speed of 1 mm/min (tensile modulus of elasticity) or at a traction speed of 50 mm/min (breaking strength) on the ISO tensile bar, standard ISO/CD 3167, type Al, 170×20/10×4 mm, at a temperature of 23° C.

Impact strength, notch impact strength according to Charpy were measured according to ISO 179/1 (2023) or ISO 179/2 (2020) on the ISO test bar, standard ISO/CD 3167, type B1, 80×10×4 mm, at a temperature of 23° C. and −45° C.

The oxygen index (LOI=limiting oxygen index) is the minimum oxygen concentration of an oxygen-nitrogen mixture, given in volume percent, at which the combustion of a vertically-arranged test sample (ISO test bar, standard ISO/CD 3167, type B1, 80×10×4 mm), persists under test conditions. The LOI is determined according to DIN EN ISO 4589-1 and 4589-2 (2017). Prior to the LOI determination, the test specimens were conditioned for a duration of 7 days at a temperature of 23° C. and a relative humidity of 50%.

The MVR (Melt Volume-Flow Rate) is determined according to ISO 1133 (2012) by means of a capillary rheometer, wherein the material (granules) were melted in a heatable cylinder at a temperature of 275° C. and pressed at a pressure resulting from the bearing load of 5 kg through a defined nozzle (capillary). The emerging volume of the polymer melt was determined as a function of time.

1-15. (canceled)

16. A polyamide molding compound comprising:
(A) 34-88 wt % semicrystalline, aliphatic polyamide with a C/N ratio of at least 8;
(B) 6-21 wt % of a flame retardant consisting of:
(B1) 50-100 wt % of at least one metal phosphinate; and
(B2) 0-50 wt % of at least one flame retardant synergist and/or at least one flame retardant containing nitrogen and phosphorus;
where the sum of the (B1) and (B2) yields 100 wt % of the (B);
(C) 1-10 wt % graphite;
(D) 0-25 wt % polyamide elastomer;
(E) 0-10 wt % plasticizer;
(F) 0-10 wt % polyolefin; and
(G) 0-5 wt % additives, differing from (A) to (F);
where the sum of the weight proportions of (D) to (F) is 5 to 30 wt % relative to the sum of the weight percentages of the (A) to (G), and where the weight proportions of the (A) to (G) sum up to 100 wt %.

17. The polyamide molding compound according to claim 16, wherein polyamide (A) is a semicrystalline, aliphatic polyamide with a C/N ratio of at least 10, or is selected from the group consisting of PA610, PA612, PA614, PA616, PA1010, PA1012, PA1014, PA1016, PA11, PA12, and mixtures thereof,
or is selected from the group consisting of PA1010, PA1012, PA11, PA12, and mixtures thereof;
and/or has a solution viscosity in the range of ηᵣₑₗ=1.5-2.8, as measured at 20° C. in a solution of 0.5 g polymer dissolved in 100 ml m-cresol, according to DIN EN ISO 307:2007.

18. The polyamide molding compound according to claim 16, wherein:
the proportion of (B), relative to (A) to (G), is in the range of 7-16 wt %; and/or (B) is composed of 55-100 wt % (B1) and 0-45 wt % (B2); where the sum of the weight proportions of (B1) and (B2) results in 100 weight % of (B).

19. The polyamide molding compound according to claim 16, wherein the at least one metal phosphinate of (B1) is a phosphinic acid salt and/or a diphosphinic acid salt.

20. The polyamide molding compound according to claim 19, wherein the at least one metal phosphinate of (B1) is a phosphinic acid salt of the general formula (I) and/or formula (II): 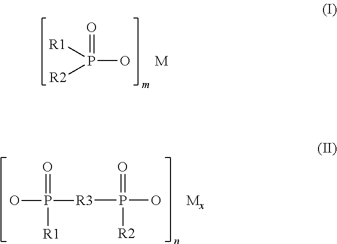
wherein:
R1 and R2 are same or different and are C₁-C₈ alkyl, linear or branched, and/or are an aryl;
R3 is C₁-C₁₀ alkylene which is linear or branched, C₆-C₁₀ arylene, alkylarylene, or arylalkylene;
M is a metal ion from the 2nd or 3rd main or subgroup of the periodic table; and
m is 2 or 3;
n is 1 or 3; and
x 1 is or 2.

21. The polyamide molding compound according to claim 16, wherein the proportion of (C) is in the range of 2-8 wt %, relative to the sum of the weight percentages of (A) to (G).

22. The polyamide molding compound according to claim 16, wherein the polyamide elastomer of (D) has hard segments based on polyamides PA610, PA612, PA614, PA616, PA1010, PA1012, PA1014, PA1016, PA11, or PA12, and soft segments based on a polyether diol based on ethylene oxide, propylene oxide, tetrahydrofuran, or a mixture of the same, and/or dimer diol based on dimeric fatty acids with 20-44 carbon atoms, and/or polyether diamine based on, at least one component selected from the following group: ethylene oxide, propylene oxide, tetrahydrofuran, or a mixture of the same;
wherein the polyamide hard segments have a number average molar mass in the range of 500 to 10000 g/mol;
and/or the soft segments have a number average molar mass in the range of 200-4000 g/mol;
and/or wherein the proportion of polyamide hard segments accounts for 45-95 wt %, relative to 100 wt % of (D);
and/or (D) is free of ester bonds;
and/or the proportion of (D) is in the range of 0-20 wt %, relative to the sum of the weight percentages of (A) to (G).

23. The polyamide molding compound according to claim 16, wherein:
the proportion of the plasticizer of (E) is in the range of 0-7 wt %, relative to the sum of the weight percentages of (A) to (G);
and/or in that the plasticizer of (E) is selected from the group consisting of aryl sulfonic acid amides with 2 to 12 carbon atoms, p-hydroxybenzoic acid ester with 2-20 carbon atoms in the alcohol component, organic phosphonates, organic phosphates, and silicone oils.

24. The polyamide molding compound according to claim 16, wherein (E) is a silicone oil.

25. The polyamide molding compound according to claim 16, wherein
the proportion of (F) is in the range of 0-7 wt %, relative to the sum of the weight percentages of (A) to (G);
and/or at least one polyolefin of (F) is a terpolymer of monomers selected from the group consisting of ethylene, propylene, butylene, acrylate, methacrylate, acrylic acid, methacrylic acid, maleic anhydride, glycidyl methacrylate, and a diene;
and/or at least one polyolefin of (F) is selected from the group consisting of ethylene propylene rubber, ethylene propylene diene rubber, and styrene-containing elastomers;
and/or at least one polyolefin of (F) is functionalized with maleic anhydride, acrylic acid, and/or glycidyl methacrylate, or (F) is a polyolefin ionomer, in which the present carboxyl groups are partially or completely neutralized by metal bases.

26. The polyamide molding compound according to claim 16, wherein the proportion of (G) is in the range of 0-2.0 wt % relative to the sum of the weight percentages of (A) to (G).

27. The polyamide molding compound according to claim 16, which consists of:
(A) 34-88 wt % polyamide selected from the group consisting of PA1010, PA1012, PA11, PA12 and mixtures of the same;
(B) 6-21 wt % flame retardants, consisting of
(B1) 50-100 wt % of at least one metal phosphinate;
(B2) 0-50 wt % of at least one flame retardant synergist and/or at least one flame retardant containing nitrogen and phosphorus;
where the sum of components (B1) and (B2) yields 100 wt % of the component (B);
(C) 1-10 wt % graphite; and
(D) 0-25 wt % polyamide elastomer made of PA1010, PA1012, PA11 or PA12 polyamide hard segments and soft segments based on polyether diol made from at least one component selected from the following group: ethylene oxide, propylene oxide, and tetrahydrofuran; wherein the polyamide elastomer is free of ester bonds;
(E) 0-10 wt % plasticizer selected from N-butylbenzenesulfonamide and silicone oil;
(F) 0-10 wt % polyolefin copolymer composed from at least one or a combination of the following components: ethylene, propylene, butylene, acrylate, methacrylate, acrylic acid, and methacrylic acid;
(G) 0-5 wt % additives differing from (A) to (F);
where the sum of (D) to (F) is 5 to 30 wt % relative to the sum of the weight percentages of (A) to (G), and where the weight proportions of (A) to (G) sum to 100 wt %.

28. A method for producing a polyamide molding compound according to claim 16, wherein (A) and simultaneously (B)-(G), are mixed, and the plasticizer (E) is either separately introduced into the mixture via liquid dosing or pre-blended with (A) via a granule dosing into the mixture.

29. A component made from a polyamide molding compound according to claim 16.

30. A method for producing a component according to claim 29, wherein the polyamide molding compound is shaped into the component in an extrusion process, extrusion blow molding process, an injection molding process, or an overmolding process.
